(19) United States
(12) Patent Application Publication
(10) Pub. No.: US 2012/0088076 A1
(43) Pub. Date: Apr. 12, 2012

(54) SANITARY TISSUE PRODUCTS AND METHODS FOR MAKING SAME

(76) Inventors: Esinam Deniece Glakpe, Colerain Township, OH (US); Angela Lynn Jennings, Fairfield, OH (US); Sara Elizabeth Gordon, Cincinnati, OH (US); Naomi Ruth Nelson, Cincinnati, OH (US); André Mellin, Amberley Village, OH (US); Paul Dennis Trokhan, Hamilton, OH (US)

(21) Appl. No.: 13/267,054

(22) Filed: Oct. 6, 2011

Related U.S. Application Data
(60) Provisional application No. 61/390,795, filed on Oct. 7, 2010.

(51) Int. Cl. A47K 10/16; B32B 3/10

(52) U.S. Cl. 428/195.1

(57) ABSTRACT

Sanitary tissue products having a surface having a surface pattern including at least one line art element and at least one fragmented line art element and methods for making same are provided

### CROSS REFERENCE TO RELATED APPLICATION(S)

This application claims the benefit of U.S. Provisional Application No. 61/390,795, filed Oct. 7, 2010.

### FIELD OF THE INVENTION

The present invention relates to sanitary tissue products having a surface comprising a surface pattern and more particularly to sanitary tissue products having a surface comprising a surface pattern comprising at least one line art element and at least one fragmented line art element and methods for making same.

### BACKGROUND OF THE INVENTION

Sanitary tissue products comprising surfaces comprising surface patterns are known in the art. For example, embossed and/or wet-molded sanitary tissue products that comprise a surface comprising a surface pattern are known in the art. Surface patterns have been used for aesthetic reasons and for providing consumers with a perception about a characteristic or property of the sanitary tissue products.

Known surface patterns for sanitary tissue products include surface patterns that impart a woven appearance to the surface by associating discrete elements, such as dot embossments, to form the appearance of a woven structure as shown in FIG. 1. Such surface patterns utilize similar if not identical elements that are arranged to provide the woven appearance. In addition, known surface patterns also comprise grid-like networks to impart an appearance such as a net as shown in FIG. 2. Further, known surface patterns also comprise wavy lines and dots as shown in FIG. 3. Lastly, known surface patterns include discrete elements that impart an image, such as a flower, butterfly, or geometric shape, to the surface as shown in FIG. 4. None of such known surface patterns comprise a line art element and a fragmented line art element that is complementary to the line art element.

Certain consumers of sanitary tissue products, such as bath tissue, paper towels and/or facial tissue, continue to desire surface patterns on their sanitary tissue product that provide or are perceived as providing a superior sanitary tissue product compared to known sanitary tissue products.

Accordingly, there is a need for a sanitary tissue product comprising a novel surface pattern, for example a surface pattern that provides consumers with a perception of superiority compared to sanitary tissue products comprising known surface patterns.

### SUMMARY OF THE INVENTION

The present invention fulfills the needs described above by providing a sanitary tissue product comprising a novel surface pattern, for example a surface pattern that comprises a line art element and a complementary fragmented line art element.

In one example of the present invention, a sanitary tissue product having a surface comprising a surface pattern, wherein the surface pattern comprises a design element that comprises a first line art element and a first complementary fragmented line art element, is provided.

In another example of the present invention, a sanitary tissue product having a surface comprising a surface pattern, wherein the surface pattern comprises fragments of a design element that when combined form a whole design element and wherein the sanitary tissue product is void of a whole design element, is provided.

In another example of the present invention, a sanitary tissue product having a surface comprising a surface pattern, wherein the surface pattern comprises a plurality of filamentary line patterns, wherein at least one of the filamentary line patterns comprises a first line art element and a first fragmented line art element, is provided.

In yet another example of the present invention, a method for making a sanitary tissue product according to the present invention is provided.

The present invention provides sanitary tissue products comprising a novel surface pattern and methods for making such sanitary tissue products.

### BRIEF DESCRIPTION OF THE DRAWINGS

FIG. 1 is a top plan view of a prior art surface pattern for a sanitary tissue product;

FIG. 2 is a top plan view of another prior art surface pattern for a sanitary tissue product;

FIG. 3 is a top plan view of another prior art surface pattern for a sanitary tissue product;

FIG. 4 is a top plan view of another prior art surface pattern for a sanitary tissue product;

FIG. 5A is a schematic representation of an example of a whole design element according to the present invention;

FIG. 5B is a schematic representation of an example of a fragment of the whole design of FIG. 5A;

FIG. 6A is a schematic representation of an example of a filamentary line pattern according to the present invention;

FIG. 6B is a mirror image of FIG. 6A;

FIG. 7 is a top plan view of an example of a sanitary tissue product comprising a surface pattern according to the present invention;

FIG. 8 is a top plan view of another example of a sanitary tissue product comprising a surface pattern according to the present invention;

FIG. 9 is a top plan view of another example of a sanitary tissue product comprising a surface pattern according to the present invention; and

FIG. 10 is a top plan view of another example of a sanitary tissue product comprising a surface pattern according to the present invention.

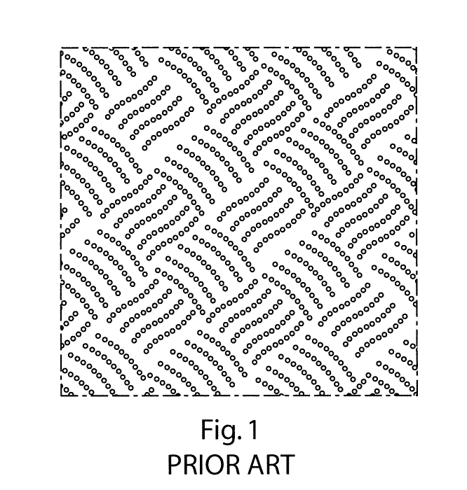

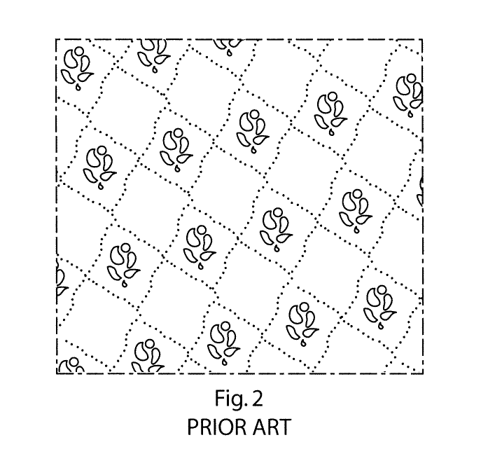

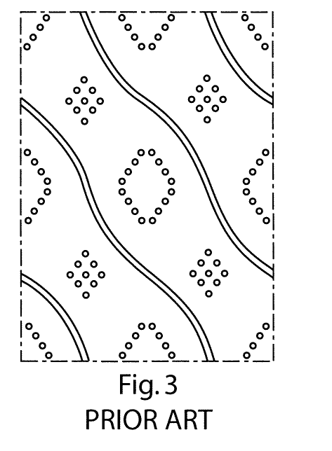

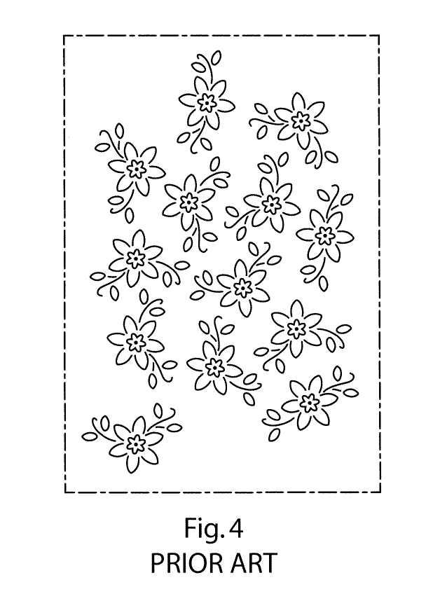

### DETAILED DESCRIPTION OF THE INVENTION

### Definitions

“Sanitary tissue product” as used herein means a soft, low density (i.e. < about 0.15 g/cm³ measured at 95 g/in²) sanitary tissue product useful as a wiping implement for post-urinary and post-bowel movement cleaning (toilet tissue), for otorhinolaryngological discharges (facial tissue), multi-functional absorbent and cleaning uses (absorbent towels), napkins, and wet and dry wipes. The sanitary tissue product may be convolutedly wound upon itself about a core or without a core to form a sanitary tissue product roll. Alternatively, the sanitary tissue product may be in the form of discrete sheets.

The sanitary tissue products and/or fibrous structures of the present invention may exhibit a basis weight of greater than 15 g/m² (9.2 lbs/3000 ft²) to about 120 g/m² (73.8 lbs/3000 ft²) and/or from about 15 g/m² (9.2 lbs/3000 ft²) to about 110 g/m² (67.7 lbs/3000 ft²) and/or from about 20 g/m² (12.3 lbs/3000 ft²) to about 100 g/m² (61.5 lbs/3000 ft²) and/or from about 30 (18.5 lbs/3000 ft²) to 90 g/m² (55.4 lbs/3000 ft²). In addition, the sanitary tissue products and/or fibrous structures of the present invention may exhibit a basis weight between about 40 g/m² (24.6 lbs/3000 ft²) to about 120 g/m² (73.8 lbs/3000 ft²) and/or from about 50 g/m² (30.8 lbs/3000 ft²) to about 110 g/m² (67.7 lbs/3000 ft²) and/or from about 55 g/m² (33.8 lbs/3000 ft²) to about 105 g/m² (64.6 lbs/3000 ft²) and/or from about 60 (36.9 lbs/3000 ft²) to 100 g/m² (61.5 lbs/3000 ft²).

The sanitary tissue products of the present invention may exhibit a density (measured at 95 g/in²) of less than about 0.60 g/cm³ and/or less than about 0.30 g/cm³ and/or less than about 0.20 g/cm³ and/or less than about 0.10 g/cm³ and/or less than about 0.07 g/cm³ and/or less than about 0.05 g/cm³ and/or from about 0.01 g/cm³ to about 0.20 g/cm³ and/or from about 0.02 g/cm³ to about 0.10 g/cm³.

The sanitary tissue products of the present invention may be in the form of sanitary tissue product rolls. Such sanitary tissue product rolls may comprise a plurality of connected, but perforated sheets of fibrous structure, that are separably dispensable from adjacent sheets.

The sanitary tissue products of the present invention may comprise additives such as softening agents such as silicones and quaternary ammonium compounds, temporary wet strength agents, permanent wet strength agents, bulk softening agents, lotions, silicones, wetting agents, latexes, especially surface-pattern-applied latexes, dry strength agents such as carboxymethylcellulose and starch, and other types of additives suitable for inclusion in and/or on sanitary tissue products.

“Fibrous structure” as used herein means a structure that comprises one or more filaments and/or fibers. In one example, a fibrous structure according to the present invention means an orderly arrangement of filaments and/or fibers within a structure in order to perform a function. Non-limiting examples of fibrous structures of the present invention include paper, fabrics (including woven, knitted, and non-woven), and absorbent pads (for example for diapers or feminine hygiene products).

Non-limiting examples of processes for making fibrous structures include known wet-laid papermaking processes, which includes rush transfer and/or fabric creping and/or belt creping and/or wet-micro contraction and/or wet pressing papermaking processes and air-laid papermaking processes. Such processes typically include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous slurry is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g. a sanitary tissue product.

The fibrous structures of the present invention may be homogeneous or may be layered. If layered, the fibrous structures may comprise at least two and/or at least three and/or at least four and/or at least five layers.

The fibrous structures of the present invention may be creped or uncreped.

The fibrous structures of the present invention may be co-formed fibrous structures.

“Co-formed fibrous structure” as used herein means that the fibrous structure comprises a mixture of at least two different materials wherein at least one of the materials comprises a filament, such as a polypropylene filament, and at least one other material, different from the first material, comprises a solid additive, such as a fiber and/or a particulate. In one example, a co-formed fibrous structure comprises solid additives, such as fibers, such as wood pulp fibers, and filaments, such as polypropylene filaments.

“Solid additive” as used herein means a fiber and/or a particulate.

“Particulate” as used herein means a granular substance or powder.

“Fiber” and/or “Filament” as used herein means an elongate particulate having an apparent length greatly exceeding its apparent width, i.e. a length to diameter ratio of at least about 10. In one example, a “fiber” is an elongate particulate as described above that exhibits a length of less than 5.08 cm (2 in.) and a “filament” is an elongate particulate as described above that exhibits a length of greater than or equal to 5.08 cm (2 in.).

Fibers are typically considered discontinuous in nature. Non-limiting examples of fibers include wood pulp fibers and synthetic staple fibers such as polyester fibers.

Filaments are typically considered continuous or substantially continuous in nature. Filaments are relatively longer than fibers. Non-limiting examples of filaments include meltblown and/or spunbond filaments. Non-limiting examples of materials that can be spun into filaments include natural polymers, such as starch, starch derivatives, cellulose and cellulose derivatives, hemicellulose, hemicellulose derivatives, and synthetic polymers including, but not limited to polyvinyl alcohol filaments and/or polyvinyl alcohol derivative filaments, and thermoplastic polymer filaments, such as polyesters, nylons, polyolefins such as polypropylene filaments, polyethylene filaments, and biodegradable or compostable thermoplastic fibers such as polylactic acid filaments, polyhydroxyalkanoate filaments and polycaprolactone filaments. The filaments may be monocomponent or multicomponent, such as bicomponent filaments.

In one example of the present invention, “fiber” refers to papermaking fibers. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. U.S. Pat. No. 4,300,981 and U.S. Pat. No. 3,994,771 are incorporated herein by reference for the purpose of disclosing layering of hardwood and softwood fibers. Also applicable to the present invention are fibers derived from recycled paper, which may contain any or all of the above categories as well as other non-fibrous materials such as fillers and adhesives used to facilitate the original papermaking. Non-limiting examples of suitable hardwood pulp fibers include eucalyptus and acacia. Non-limiting examples of suitable softwood pulp fibers include Southern Softwood Kraft (SSK) and Northern Softwood Kraft (NSK).

In addition to the various wood pulp fibers, other cellulosic fibers such as cotton linters, rayon, lyocell and bagasse can be used in this invention. Other sources of cellulose in the form of fibers or capable of being spun into fibers include grasses and grain sources.

In addition, trichomes such as from “lamb's ear” plants and seed hairs can also be utilized in the fibrous structures of the present invention.

“Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121.

“Basis Weight” as used herein is the weight per unit area of a sample reported in lbs/3000 ft² or g/m² and is measured according to the Basis Weight Test Method described herein.

“Caliper” as used herein means the macroscopic thickness of a fibrous structure. Caliper is measured according to the Caliper Test Method described herein.

“Bulk” as used herein is calculated as the quotient of the Caliper, expressed in microns, divided by the Basis Weight, expressed in grams per square meter. The resulting Bulk is expressed as cubic centimeters per gram. For the products of this invention, Bulks can be greater than about 3 cm³/g and/or greater than about 6 cm³/g and/or greater than about 9 cm³/g and/or greater than about 10.5 cm³/g up to about 30 cm³/g and/or up to about 20 cm³/g . The products of this invention derive the Bulks referred to above from the basesheet, which is the sheet produced by the tissue machine without post treatments such as embossing. Nevertheless, the basesheets of this invention can be embossed to produce even greater bulk or aesthetics, if desired, or they can remain unembossed. In addition, the basesheets of this invention can be calendered to improve smoothness or decrease the Bulk if desired or necessary to meet existing product specifications.

“Density” as used herein is calculated as the quotient of the Basis Weight expressed in grams per square meter divided by the Caliper expressed in microns.

“Machine Direction” or “MD” as used herein means the direction parallel to the flow of the fibrous structure through the fibrous structure making machine and/or sanitary tissue product manufacturing equipment.

“Cross Machine Direction” or “CD” as used herein means the direction parallel to the width of the fibrous structure making machine and/or sanitary tissue product manufacturing equipment and perpendicular to the machine direction.

“Ply” as used herein means an individual, integral fibrous structure.

“Plies” as used herein means two or more individual, integral fibrous structures disposed in a substantially contiguous, face-to-face relationship with one another, forming a multi-ply sanitary tissue product. It is also contemplated that an individual, integral fibrous structure can effectively form a multi-ply sanitary tissue product, for example, by being folded on itself.

“Surface pattern” with respect to a sanitary tissue product in accordance with the present invention means herein a pattern that is present on at least one surface of the sanitary tissue product. The surface pattern may be a textured surface pattern such that the surface of the sanitary tissue product comprises protrusions and/or depressions as part of the surface pattern. For example, the surface pattern may comprise embossments. The surface pattern may be a non-textured surface pattern such that the surface of the sanitary tissue product does not comprise protrusions and/or depressions as part of the surface pattern. For example, the surface pattern may be printed on a surface of the sanitary tissue product. In another example, the surface pattern may comprise regions of texture and regions of non-texture.

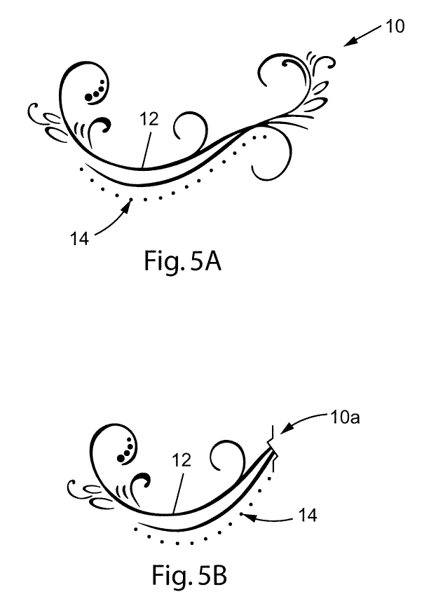

“Design element” as used herein means an individual unit or portion of an individual unit that forms the surface pattern. For example, a design element 10 according to the present invention is shown in FIG. 5A. A “whole design element” means a complete design element (in other words, no portion of the design element is truncated). For example, FIG. 5A shows an example of a whole design element. A “fragmented design element” is a design element that is not complete (in other words, at least one portion of the design element is truncated or missing). FIG. 5B shows an example of a fragmented design element 10a, which is a fragment or portion of the whole design element 10 shown in FIG. 5A. Fragments of the design element may be present on the surface of the sanitary tissue product. In one example, a surface pattern present on a sanitary tissue product's surface may be void of whole design elements, but comprise fragments of a whole design element (fragmented design elements), which when combined together form a whole design element.

“Line art element” as used herein means a continuous or substantially continuous line segment. For example, a line art element 12 according to the present invention is shown in FIGS. 5A and 5B.

“Fragmented line art element” as used herein means a combination of discrete, adjacent elements that when connected to one another form a line segment. For example, a fragmented line art element 14 according to the present invention is shown in FIGS. 5A and 5B.

“Complementary” as used herein, for example with respect to a fragmented line art element being complementary to a line art element within a design element and/or fragmented design element, means that the fragmented line art element corresponds in character and/or kind to the line art element. In one example, the complementary fragmented line art element or portions thereof are parallel and/or substantially parallel to the line art element. In one example, the complementary fragmented line art element shadows (as in an imperfect imitation or copy of) the line art element. In another example, the complementary fragmented line art element is separated from the line art element within the design element and/or fragmented design element at a maximum distance along their respective lengths of less than 5 cm and/or less than 4 cm and/or less than 3 cm and/or less than 2 cm and/or less than 1 cm and/or less than 0.5 cm and/or greater than 0.05 cm and/or greater than 0.1 cm.

In one example, the complementary fragmented line art element of the present invention emphasizes and/or draws attention to the line art element that it is complementary to.

“Curvilinear” as used herein with respect to line art elements and/or fragmented line art elements means that the line art element and/or fragment line art element contains at least one curve along its length. In other words, the line art element and/or fragmented line art element is not a straight line. The curvilinear line art elements and/or curvilinear fragmented line art elements provide a softer and/or more luxurious (not as engineered) appearance to the surface pattern and ultimately to the sanitary tissue product upon which the surface pattern is present.

“Terminal ends” as used herein means a point at which the line art element terminates.

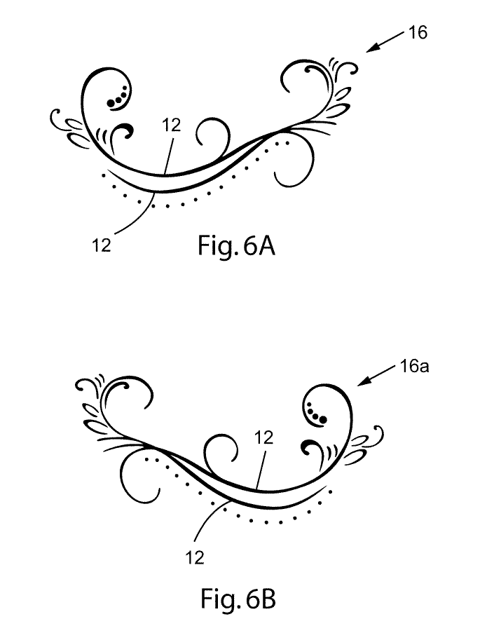

“Filamentary line pattern” as used herein means an image and/or actual area of a midline of a strip under a homeomorphism of the strip onto itself. In one example, a filamentary line pattern is the area between two imaginary parallel or substantially parallel lines. FIG. 6A shows an example of a filamentary line pattern 16, which is also a design element formed from two continuous lines 12 according to the present invention. FIG. 6B illustrates an example of a filamentary line pattern 16a, which is a mirror image of the filamentary line pattern 16 shown in FIG. 6A.

“Embossed” as used herein with respect to a sanitary tissue product means a sanitary tissue product that has been subjected to a process which converts a smooth surfaced fibrous structure to a decorative surface by replicating a design on one or more emboss rolls, which form a nip through which the fibrous structure passes. Embossed does not include creping, microcreping, printing or other processes that may impart a texture and/or decorative pattern to a fibrous structure.

“Line embossment” as used herein means an embossment that comprises a continuous line that has an aspect ratio of greater than 1.5:1 and/or greater than 1.75:1 and/or greater than 2:1 and/or greater than 5:1. In one example, the line embossment exhibits a length of at least 2 mm and/or at least 4 mm and/or at least 6 mm and/or at least 1 cm to about 10.16 cm and/or to about 8 cm and/or to about 6 cm and/or to about 4 cm.

The continuous lines and/or broken lines of the filamentary line pattern and/or design element of the present invention may be formed by a line embossment or line embossments. In one example, the continuous lines and/or broken lines of the filamentary line pattern and/or design element of the present invention may be formed by lines that are formed by wet molding and/or a through-air-drying fabric and/or an imprinted through-air-drying fabric.

“Dot embossment” as used herein means an embossment that exhibits an aspect ratio of about 1:1. Non-limiting examples of dot embossments are embossments that are shaped like circles, squares, rectangles (dashes) and/or triangles. A plurality of dot embossments may form a broken line of a filamentary line pattern and/or design element.

“Water-resistant” as it refers to a surface pattern or part thereof means that a pattern retains its structure and/or integrity after being saturated by water and the pattern is still visible to a consumer. In one example, the continuous lines and/or broken lines of the filamentary pattern and/or filamentary line pattern may be water-resistant.

### Sanitary Tissue Product

The sanitary tissue product of the present invention comprises a surface having a surface pattern. The surface pattern comprises one or more and/or two or more design elements, whole design elements and/or fragments of a whole design element (fragmented design elements). In one example, the surface pattern comprises two or more design elements. In another example, the surface pattern comprises two or more design elements that are mirror images and/or translations of one another. In still another example, the surface pattern comprises at least one design element and at least one fragmented design element. In even another example, the surface pattern consists of fragmented design elements, two or more of which may when combined together form a whole design element.

A sanitary tissue product of the present invention may have a surface comprising a surface pattern, wherein the surface pattern comprises fragments of a design element that when combined together form a whole design element. Such a sanitary tissue product may be void of a whole design element and/or less than 20% and/or less than 10% and/or less than 5% and/or less than 3% of the surface pattern on the sanitary tissue product may comprise a whole design element.

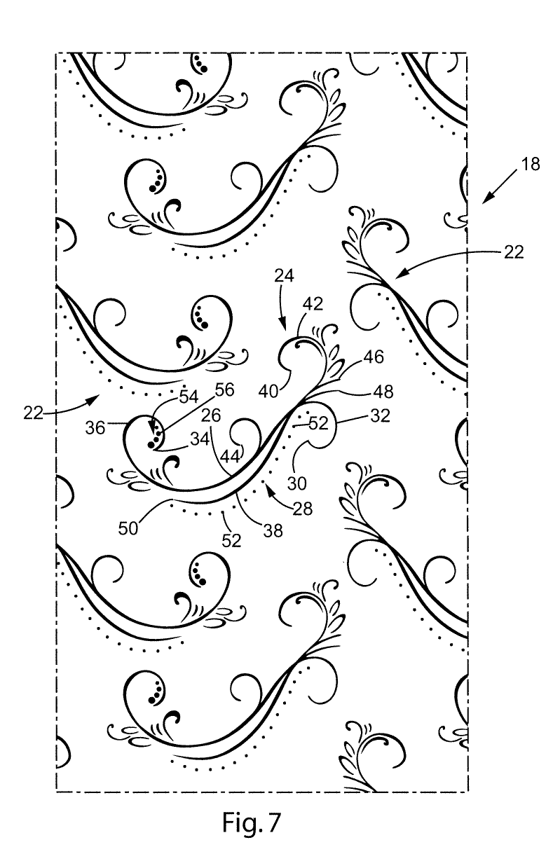

In one example, as shown in FIG. 7, a sanitary tissue product 18 comprises a surface 20 having a surface pattern 22. The surface pattern 22 comprises a design element 24. The design element 24 comprises a line art element 26 and a first complementary fragmented line art element 28.

The line art element 26 may comprise a curvilinear line art element. The line art elements 26 of the present invention may comprise line embossments. The line art element 26 may comprise a first terminal end 30. The line art element 26 may comprise a curve 32 adjacent to the first terminal end 30. The line art element 26 may further comprise a second terminal end 34. The line art element 26 may comprise a curve 36 adjacent to the second terminal end 34.

The design element 24 may further comprise a second line art element 38. The second line art element 38 may be connected to the first line art element 26. In one example, the second line art element 38 may intersect the first line art element 26. The second line art element 38 may be curvilinear. Further, the second line art element 38 may comprise a terminal end 40. The second line art element 38 may comprise a curve 42 adjacent to the terminal end 40.

The design element 24 may further comprise additional line art elements.

In one example, the line art element 26 may comprise a plurality of terminal ends 30, 34, 44, 46, 48. The line art element 26 may taper to at least one of the terminal ends 30, 34, 44, 46, 48. In addition, the line art element 26 may exhibit a varying width along its length.

In another example, the second line art element 38 may comprise a plurality of terminal ends 40, 50. The second line art element 38 may taper to at least one of the terminal ends 40, 50. In addition, the second line art element 38 may exhibit a varying width along its length.

The complementary fragmented line art element 28 may comprise discrete dots 52, for example dot embossments. The discrete dots 52 may be different sizes. In another example, the fragmented line art element 28 may comprise discrete dashes, circles, squares, triangles, ellipses and/or other suitable shapes and mixtures thereof

The design element 24 may further comprise a second fragmented line art element 54. The second fragmented line art element 54 may be the same or different from the complementary fragmented line art element 28. The second fragmented line art element 54 may comprise discrete dots 56, for example dot embossments. The discrete dots 56 may be different sizes. In another example, the second fragmented line art element 54 may comprise discrete dashes, circles, squares, triangles, ellipses and/or other suitable shapes and mixtures thereof.

The second fragmented line art element 54 may be complementary to one or more line art elements within the design element 24, for example complementary to the line art element 26 and/or the second line art element 38.

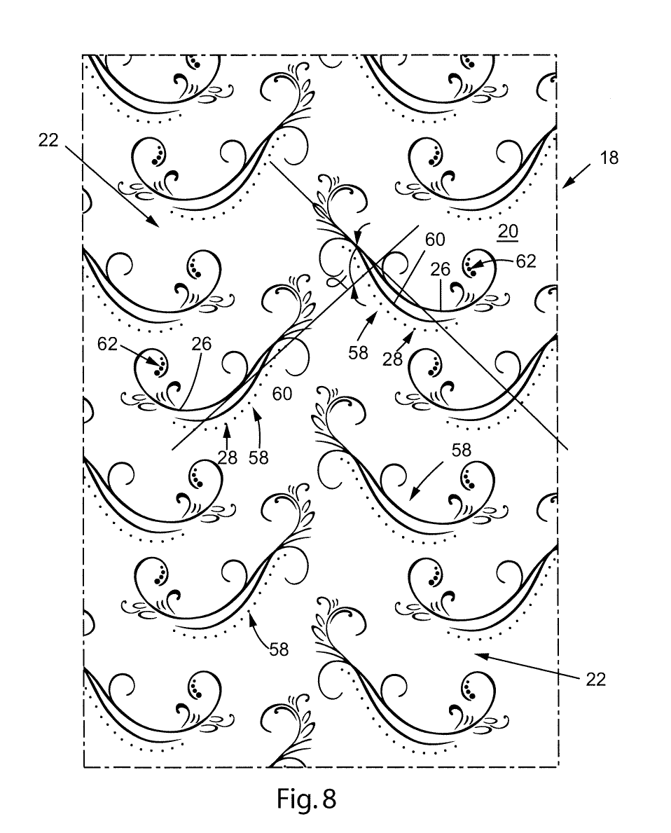

As shown in FIG. 8, a sanitary tissue product 18 according to the present invention may have a surface 20 comprising a surface pattern 22. The surface pattern 22 may comprise a plurality of filamentary line patterns 58, wherein the filamentary line patterns 58 comprise a line art element 26 and a fragmented line art element 28. The fragmented line art element 28 may be complementary to the line art element 26. At least two of the filamentary line patterns 58 may be oriented at an angle a (formed by the intersection of lines parallel to the major axes of the respective two or more filamentary line patterns) of greater than 20° but less than 160° and/or from about 45° to about 135° and/or from about 65° to about 115° and/or from about 75° to about 105° and/or about 90° relative to one another as shown in FIG. 8.

In one example, at least one of the filamentary line patterns 58 further comprises one or more additional line art elements 60. In still another example, at least one of the filamentary line patterns 58 may further comprise one or more additional fragmented line art elements 62. One or more of the additional fragmented line art elements 62 may be complementary to one or more of the line art elements 26, 60.

Further, the surface pattern 22 may comprise two or more of the filamentary line patterns 58.

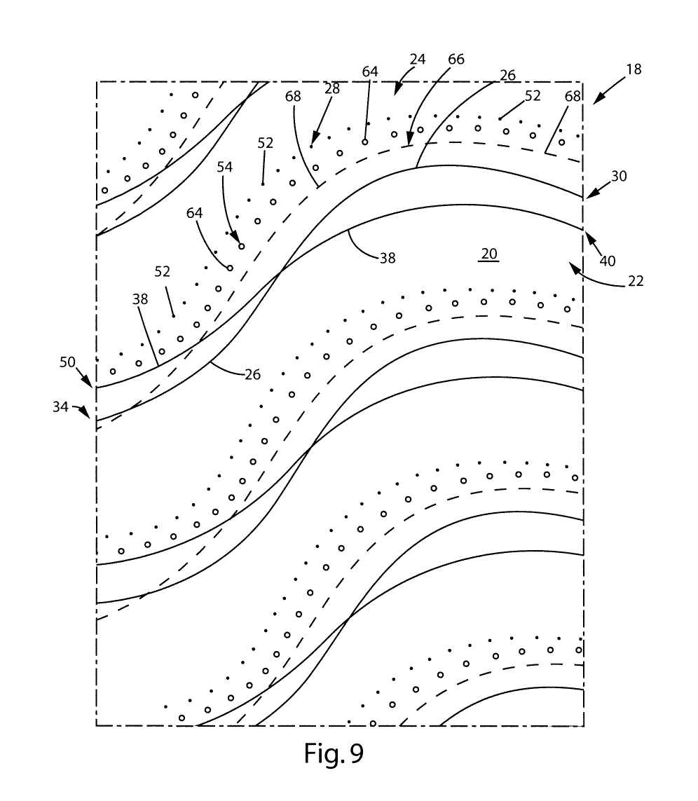

FIG. 9 shows another example of a sanitary tissue product according to the present invention. The sanitary tissue product 18 comprises a surface 20 having a surface pattern 22. The surface pattern 22 comprises a design element 24. The design element 24 comprises a line art element 26 and a first complementary fragmented line art element 28.

The line art element 26 may comprise a curvilinear line art element. The line art elements 26 of the present invention may comprise line embossments. The line art element 26 may comprise a first terminal end 30. The line art element 26 may further comprise a second terminal end 34.

The design element 24 may further comprise a second line art element 38. The second line art element 38 may be connected to the first line art element 26. In one example, the second line art element 38 may intersect the first line art element 26. The second line art element 38 may be curvilinear.

The design element 24 may further comprise additional line art elements.

The second line art element 38 may comprise a plurality of terminal ends 40, 50. The second line art element 38 and/or first line art element 26 may taper to at least one of their respective terminal ends. In addition, the first line art element 26 and/or the second line art element 38 may exhibit a varying width along their lengths.

The complementary fragmented line art element 28 may comprise discrete dots (circles) 52, for example dot embossments. The discrete dots 52 may be different sizes. In another example, the fragmented line art element 28 may comprise discrete dashes, squares, triangles, ellipses and/or other suitable shapes and mixtures thereof.

The design element 24 may further comprise a second fragmented line art element 54. The second fragmented line art element 54 may be the same or different from the complementary fragmented line art element 28. The second fragmented line art element 54 may comprise discrete circles 64. The discrete circles 64 may be different sizes. In another example, the second fragmented line art element 54 may comprise discrete dashes, squares, triangles, ellipses and/or other suitable shapes and mixtures thereof.

The second fragmented line art element 54 may be complementary to one or more line art elements within the design element 24, for example complementary to the line art element 26 or the second line art element 38.

The design element 24 may further comprise a third fragmented line art element 66. The third fragmented line art element 66 may be the same or different from the complementary fragmented line art element 28. The third fragmented line art element 66 may comprise discrete dashes 68. The discrete dashes 68 may be different sizes. In another example, the third fragmented line art element 66 may comprise discrete dashes, squares, triangles, ellipses and/or other suitable shapes and mixtures thereof.

The third fragmented line art element 66 may be complementary to one or more line art elements within the design element 24, for example complementary to the line art element 26 or the second line art element 38.

The surface pattern 22 shown in FIG. 9 may comprise a plurality of design elements 24.

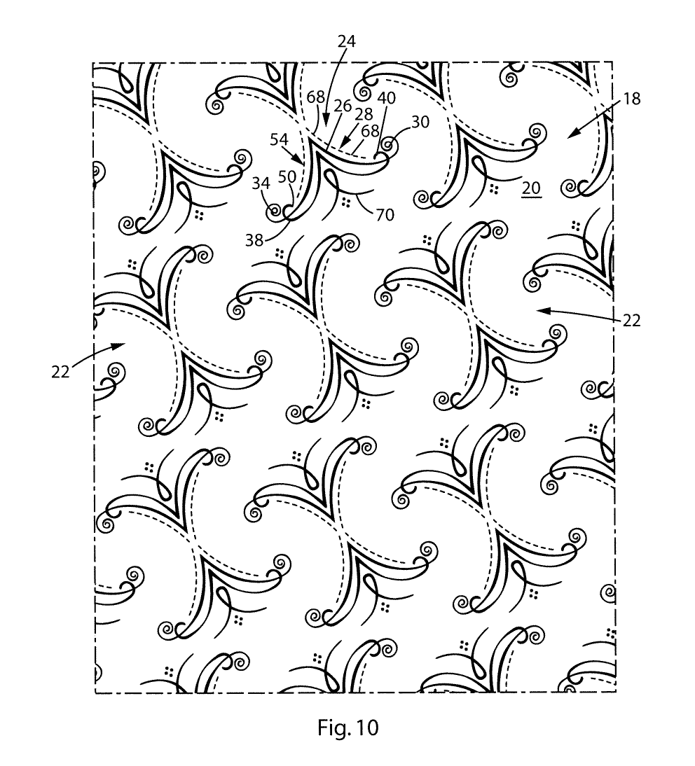

As shown in FIG. 10, another example of a sanitary tissue product 18 according to the present invention comprises a surface 20 comprising a surface pattern 22. The surface pattern 22 comprises a design element 24. The design element 24 comprises a line art element 26 and a first complementary fragmented line art element 28.

The line art element 26 may comprise a curvilinear line art element. The line art elements 26 of the present invention may comprise line embossments. The line art element 26 may comprise a first terminal end 30. The line art element 26 may further comprise a second terminal end 34.

The design element 24 may further comprise a second line art element 38. The second line art element 38 may be connected to the first line art element 26. In one example, the second line art element 38 may intersect the first line art element 26. The second line art element 38 may be curvilinear.

The design element 24 may further comprise additional line art elements.

The second line art element 38 may comprise a plurality of terminal ends 40, 50. The second line art element 38 and/or first line art element 26 may taper to at least one of their respective terminal ends. In addition, the first line art element 26 and/or the second line art element 38 may exhibit a varying width along their lengths.

The complementary fragmented line art element 28 may comprise discrete dashes 68, for example dot embossments. The discrete dashes 68 may be different sizes. In another example, the fragmented line art element 28 may comprise discrete squares, triangles, ellipses and/or other suitable shapes and mixtures thereof.

The design element 24 may further comprise a second fragmented line art element 54. The second fragmented line art element 54 may be the same or different from the complementary fragmented line art element 28. The second fragmented line art element 54 may comprise discrete dashes 68. The discrete dashes 68 may be different sizes. In another example, the second fragmented line art element 54 may comprise discrete squares, triangles, ellipses and/or other suitable shapes and mixtures thereof.

The second fragmented line art element 54 may be complementary to one or more line art elements within the design element 24, for example complementary to the line art element 26 or the second line art element 38.

The design element 24 as shown in FIG. 10 may comprise a third line art element 70.

The surface pattern 22 shown in FIG. 10 may comprise a plurality of design elements 24. In one example, the two or more of the design elements 24 are mirror images of each other.

### Methods for Making Sanitary Tissue Products

The sanitary tissue products of the present invention may be made by any suitable process known in the art. The method may be a sanitary tissue product making process that uses a cylindrical dryer such as a Yankee (a Yankee-process) or it may be a Yankeeless process as is used to make substantially uniform density and/or uncreped sanitary tissue products.

The sanitary tissue product of the present invention may be made using a molding member. A “molding member” is a structural element that can be used as a support for an embryonic web comprising a plurality of cellulosic fibers and a plurality of synthetic fibers, as well as a forming unit to form, or “mold,” a desired microscopical geometry of the sanitary tissue product of the present invention. The molding member may comprise any element that has fluid-permeable areas and the ability to impart a microscopical three-dimensional pattern to the structure being produced thereon, and includes, without limitation, single-layer and multi-layer structures comprising a stationary plate, a belt, a woven fabric (including Jacquard-type and the like woven patterns), a band, and a roll. In one example, the molding member is a deflection member. The molding member may comprise a surface pattern according to the present invention that is imparted to the sanitary tissue product during the sanitary tissue product making process.

A “reinforcing element” is a desirable (but not necessary) element in some embodiments of the molding member, serving primarily to provide or facilitate integrity, stability, and durability of the molding member comprising, for example, a resinous material. The reinforcing element can be fluid-permeable or partially fluid-permeable, may have a variety of embodiments and weave patterns, and may comprise a variety of materials, such as, for example, a plurality of interwoven yams (including Jacquard-type and the like woven patterns), a felt, a plastic, other suitable synthetic material, or any combination thereof.

In one example of a method for making a sanitary tissue product of the present invention, the method comprises the step of contacting an embryonic fibrous web with a deflection member (molding member) such that at least one portion of the embryonic fibrous web is deflected out-of-plane of another portion of the embryonic fibrous web. The phrase “out-of-plane” as used herein means that the sanitary tissue product comprises a protuberance, such as a dome, or a cavity that extends away from the plane of the sanitary tissue product. The molding member may comprise a through-air-drying fabric having its filaments arranged to produce linear elements within the sanitary tissue products of the present invention and/or the through-air-drying fabric or equivalent may comprise a resinous framework that defines deflection conduits that allow portions of the sanitary tissue product to deflect into the conduits thus forming linear elements within the sanitary tissue products of the present invention. In addition, a forming wire, such as a foraminous member may be arranged such that linear elements within the sanitary tissue products of the present invention are formed and/or like the through-air-drying fabric, the foraminous member may comprise a resinous framework that defines deflection conduits that allow portions of the sanitary tissue product to deflect into the conduits thus forming linear elements within the sanitary tissue products of the present invention.

In another example of a method for making a sanitary tissue product of the present invention, the method comprises the steps of:
(a) providing a fibrous furnish comprising fibers;
(b) depositing the fibrous furnish onto a foraminous member to form an embryonic fibrous web;
(c) associating the embryonic fibrous web with a deflection member comprising a surface pattern such that the surface pattern; and
(d) drying said embryonic fibrous web such that the surface pattern is imparted to the dried sanitary tissue product.

In another example of a method for making a sanitary tissue product of the present invention, the method comprises the steps of:
(a) providing a fibrous structure; and
(b) imparting a surface pattern to the fibrous structure to produce the sanitary tissue product.

In another example, the step of imparting a surface pattern to a sanitary tissue product comprises contacting a molding member comprising a surface pattern with a sanitary tissue product such that the pattern is imparted to the sanitary tissue product. The molding member may be a patterned belt that comprises a surface pattern.

In another example, the step of imparting a surface pattern to a sanitary tissue product comprises passing a sanitary tissue product through an embossing nip formed by at least one embossing roll comprising a surface pattern according to the present invention such that the surface pattern is imparted to the sanitary tissue product.

### NON-LIMITING EXAMPLES

### Example 1

The following Example illustrates a non-limiting example for a preparation of a sanitary tissue product comprising a sanitary tissue product according to the present invention on a pilot-scale Fourdrinier sanitary tissue product making machine.

An aqueous slurry of eucalyptus (Aracruz Brazilian bleached hardwood kraft pulp) pulp fibers is prepared at about 3% fiber by weight using a conventional repulper, then transferred to the hardwood fiber stock chest. The eucalyptus fiber slurry of the hardwood stock chest is pumped through a stock pipe to a hardwood fan pump where the slurry consistency is reduced from about 3% by fiber weight to about 0.15% by fiber weight. The 0.15% eucalyptus slurry is then pumped and equally distributed in the top and bottom chambers of a multi-layered, three-chambered headbox of a Fourdrinier wet-laid papermaking machine.

Additionally, an aqueous slurry of NSK (Northern Softwood Kraft) pulp fibers is prepared at about 3% fiber by weight using a conventional repulper, then transferred to the softwood fiber stock chest. The NSK fiber slurry of the softwood stock chest is pumped through a stock pipe to be refined to a Canadian Standard Freeness (CSF) of about 630. The refined NSK fiber slurry is then directed to the NSK fan pump where the NSK slurry consistency is reduced from about 3% by fiber weight to about 0.15% by fiber weight. The 0.15% eucalyptus slurry is then directed and distributed to the center chamber of a multi-layered, three-chambered headbox of a Fourdrinier wet-laid papermaking machine.

The sanitary tissue product making machine has a layered headbox having a top chamber, a center chamber, and a bottom chamber where the chambers feed directly onto the forming wire. The eucalyptus fiber slurry of 0.15% consistency is directed to the top headbox chamber and bottom headbox chamber. The NSK fiber slurry is directed to the center headbox chamber. All three fiber layers are delivered simultaneously in superposed relation onto the Fourdrinier wire to form thereon a three-layer embryonic web, of which about 25% of the top side is made up of the eucalyptus fibers, about 25% is made of the eucalyptus fibers on the bottom side and about 50% is made up of the NSK fibers in the center. Dewatering occurs through the Fourdrinier wire and is assisted by a deflector and wire table vacuum boxes. The Fourdrinier wire is of an Asten Johnson 866A design. The speed of the Fourdrinier wire is about 750 feet per minute (fpm).

The embryonic wet web is transferred from the Fourdrinier wire, at a fiber consistency of about 15% at the point of transfer, to a patterned drying fabric. The speed of the patterned drying fabric is the same as the speed of the Fourdrinier wire. The drying fabric is designed to yield a pattern of low density pillow regions and high density knuckle regions. This drying fabric is formed by casting an impervious resin surface onto a fiber mesh supporting fabric. The supporting fabric is a 127×52 filament, dual layer mesh. The thickness of the resin cast is about 12 mils above the supporting fabric.

Further de-watering is accomplished by vacuum assisted drainage until the web has a fiber consistency of about 20% to 30%.

While remaining in contact with the patterned drying fabric, the web is pre-dried by air blow-through pre-dryers to a fiber consistency of about 56% by weight.

After the pre-dryers, the semi-dry web is transferred to the Yankee dryer and adhered to the surface of the Yankee dryer with a sprayed creping adhesive. The creping adhesive is an aqueous dispersion with the actives consisting of about 22% polyvinyl alcohol, about 11% CREPETROL A3025, and about 67% CREPETROL R6390. CREPETROL A3025 and CREPETROL R6390 are commercially available from Hercules Incorporated of Wilmington, Del. The creping adhesive is delivered to the Yankee surface at a rate of about 0.15% adhesive solids based on the dry weight of the web. The fiber consistency is increased to about 97% before the web is dry-creped from the Yankee with a doctor blade.

The doctor blade has a bevel angle of about 25 degrees and is positioned with respect to the Yankee dryer to provide an impact angle of about 81 degrees. The Yankee dryer is operated at a temperature of about 350° F. (177° C.) and a speed of about 750 fpm. The sanitary tissue product is wound in a roll using a surface driven reel drum having a surface speed of about 673 fpm. The sanitary tissue product may be subsequently converted into a one-ply sanitary tissue product.

The sanitary tissue product is then converted into a sanitary tissue product by loading the roll of sanitary tissue product into an unwind stand. The line speed is 800 ft/min. The sanitary tissue product is unwound and transported to a steam header where steam is applied to the sanitary tissue product at a rate of 327-383 g/min. The steam pressure is 29-38 psi and the steam temperature is 270-282° F. The sanitary tissue product is then transported to an emboss stand where the sanitary tissue product is strained to form a surface pattern according to the present invention in the sanitary tissue product. The embossed sanitary tissue product is then transported to a winder where it is wound onto a core to form a log. The log of sanitary tissue product is then transported to a log saw where the log is cut into finished sanitary tissue product rolls. The sanitary tissue product is soft, flexible and absorbent.

### Example 2

A sanitary tissue product in accordance with the present invention is prepared using a sanitary tissue product making machine having a layered headbox having a top chamber, a center chamber, and a bottom chamber. A eucalyptus fiber slurry is pumped through the top headbox chamber, a eucalyptus fiber slurry is pumped through the bottom headbox chamber (i.e. the chamber feeding directly onto the forming wire) and, finally, an NSK fiber slurry is pumped through the center headbox chamber and delivered in superposed relation onto the Fourdrinier wire to form thereon a three-layer embryonic web, of which about 33% of the top side is made up of the eucalyptus blended fibers, 33% is made of the eucalyptus fibers on the bottom side and 33% is made up of the NSK fibers in the center. Dewatering occurs through the Fourdrinier wire and is assisted by a deflector and vacuum boxes. The Fourdrinier wire is of a 5-shed, satin weave configuration having 87 machine-direction and 76 cross-machine-direction monofilaments per inch, respectively. The speed of the Fourdrinier wire is about 750 fpm (feet per minute).

The embryonic wet web is transferred from the Fourdrinier wire, at a fiber consistency of about 15% at the point of transfer, to a patterned drying fabric. The speed of the patterned drying fabric is the same as the speed of the Fourdrinier wire. The drying fabric is designed to yield a pattern of substantially machine direction oriented linear channels having a continuous network of high density (knuckle) areas. This drying fabric is formed by casting an impervious resin surface onto a fiber mesh supporting fabric. The supporting fabric is a 45×52 filament, dual layer mesh. The thickness of the resin cast is about 11 mils above the supporting fabric.

Further de-watering is accomplished by vacuum assisted drainage until the web has a fiber consistency of about 20% to 30%.

While remaining in contact with the patterned drying fabric, the web is pre-dried by air blow-through pre-dryers to a fiber consistency of about 65% by weight.

After the pre-dryers, the semi-dry web is transferred to the Yankee dryer and adhered to the surface of the Yankee dryer with a sprayed creping adhesive. The creping adhesive is an aqueous dispersion with the actives consisting of about 22% polyvinyl alcohol, about 11% CREPETROL A3025, and about 67% CREPETROL R6390. CREPETROL A3025 and CREPETROL R6390 are commercially available from Hercules Incorporated of Wilmington, Del. The creping adhesive is delivered to the Yankee surface at a rate of about 0.15% adhesive solids based on the dry weight of the web. The fiber consistency is increased to about 97% before the web is dry creped from the Yankee with a doctor blade.

The doctor blade has a bevel angle of about 25 degrees and is positioned with respect to the Yankee dryer to provide an impact angle of about 81 degrees. The Yankee dryer is operated at a temperature of about 350° F. (177° C.) and a speed of about 750 fpm. The sanitary tissue product is wound in a roll using a surface driven reel drum having a surface speed of about 656 feet per minute. The sanitary tissue product is subjected to an embossing operation that imparts a surface pattern according to the present invention to a surface of the sanitary tissue product. The sanitary tissue product may be subsequently converted into a two-ply sanitary tissue product having a basis weight of about 39 g/m². For each ply, the outer layer having the eucalyptus fiber furnish is oriented toward the outside in order to form the consumer facing surfaces of the two-ply sanitary tissue product.

The sanitary tissue product is soft, flexible and absorbent.

### Test Methods

Unless otherwise specified, all tests described herein including those described under the Definitions section and the following test methods are conducted on samples that have been conditioned in a conditioned room at a temperature of 23° C.±2.2° C. and a relative humidity of 50%±10% for 2 hours prior to the test. All plastic and paper board packaging materials must be carefully removed from the paper samples prior to testing. Discard any damaged product. All tests are conducted in such conditioned room.

### Basis Weight Test Method

Basis weight of a sanitary tissue product sample is measured by selecting twelve (12) usable units (also referred to as sheets) of the sanitary tissue product and making two stacks of six (6) usable units each. Perforation must be aligned on the same side when stacking the usable units. A precision cutter is used to cut each stack into exactly 8.89 cm×8.89 cm (3.5 in.×3.5 in.) squares. The two stacks of cut squares are combined to make a basis weight pad of twelve (12) squares thick. The basis weight pad is then weighed on a top loading balance with a minimum resolution of 0.01 g. The top loading balance must be protected from air drafts and other disturbances using a draft shield. Weights are recorded when the readings on the top loading balance become constant. The Basis Weight is calculated as follows:

$$Basis Weight ( lbs \text{/} 3000 {ft}^{2} ) = \frac{Weight of basis weight pad ( g ) \times 3000 {ft}^{2}}{\begin{matrix}453.6 g / lbs \times 12 ( usable units ) \times \\ [ 12.25 {in}^{2} ( Area of basis weight pad ) / 144 {in}^{2} ]\end{matrix}}$$

$$Basis Weight ( g / {m}^{2} ) = \frac{Weight of basis weight pad ( g ) \times 10 , 000 {cm}^{2} \text{/} {m}^{2}}{79.0321 {cm}^{2} ( Area of basis weight pad ) \times 12 ( usable units )}$$

### Caliper Test Method

Caliper of a sanitary tissue product is measured by cutting five (5) samples of sanitary tissue product such that each cut sample is larger in size than a load foot loading surface of a VIR Electronic Thickness Tester Model II available from Thwing-Albert Instrument Company, Philadelphia, Pa. Typically, the load foot loading surface has a circular surface area of about 3.14 in². The sample is confined between a horizontal flat surface and the load foot loading surface. The load foot loading surface applies a confining pressure to the sample of 15.5 g/cm². The caliper of each sample is the resulting gap between the flat surface and the load foot loading surface. The caliper is calculated as the average caliper of the five samples. The result is reported in millimeters (mm).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A sanitary tissue product having a surface comprising a surface pattern, wherein the surface pattern comprises a design element that comprises a first line art element and a first complementary fragmented line art element.

2. The sanitary tissue product according to claim 1 wherein the first line art element comprises a curvilinear line art element.

3. The sanitary tissue product according to claim 1 wherein the first line art element comprises a first terminal end.

4. The sanitary tissue product according to claim 3 wherein the first line art element comprises a curve adjacent to the first terminal end.

5. The sanitary tissue product according to claim 3 wherein the first line art element further comprises a second terminal end.

6. The sanitary tissue product according to claim 5 wherein the first line art element comprises a curve adjacent to the second terminal end.

7. The sanitary tissue product according to claim 1 wherein the first line art element comprises a plurality of terminal ends.

8. The sanitary tissue product according to claim 7 wherein the first line art element tapers to at least one of the terminal ends.

9. The sanitary tissue product according to claim 1 wherein the line art element exhibits a varying width along its length.

10. The sanitary tissue product according to claim 1 wherein the design element further comprises a second line art element.

11. The sanitary tissue product according to claim 10 wherein the second line art element is connected to the first line art element.

12. The sanitary tissue product according to claim 11 wherein the second line art element is curvilinear.

13. The sanitary tissue product according to claim 10 wherein the design element further comprises additional line art elements.

14. The sanitary tissue product according to claim 1 wherein the design element further comprises a second fragmented line art element.

15. The sanitary tissue product according to claim 14 wherein the second fragmented line art element is complementary to the first line art element.

16. The sanitary tissue product according to claim 1 wherein the surface pattern comprises two or more of the design elements.

17. The sanitary tissue product according to claim 1 wherein the surface pattern comprises two or more of the design elements that are translations and mirror images of one another.

18. A sanitary tissue product having a surface comprising a surface pattern, wherein the surface pattern comprises one or more fragments of a whole design element and wherein the sanitary tissue product is void of a whole design element.

19. The sanitary tissue product according to claim 18 wherein the surface pattern comprises two or more fragments of a whole design element such that if two or more of the fragments were combined together, a whole design element would be formed.

20. A sanitary tissue product having a surface comprising a surface pattern, wherein the surface pattern comprises a plurality of filamentary line patterns, wherein the filamentary line patterns comprise a first line art element and a first fragmented line art element.
